(19) United States
(12) Patent Application Publication
(10) Pub. No.: US 2010/0311937 A1
(43) Pub. Date: Dec. 9, 2010

(54) METHOD AND CATALYST FOR THE MANUFACTURE OF A POLYURETHANE

(75) Inventor: Arran Alexander Dickon Tulloch, Northallerton (GB)

Correspondence Address: RATNERPRESTIA, P.O. BOX 980, VALLEY FORGE, PA, 19482, US

(73) Assignee: JOHNSON MATTHEY PLC, LONDON (GB)

(21) Appl. No.: 12/743,122

(22) PCT Filed: Nov. 14, 2008
(86) PCT No.: PCT/GB08/51064

§ 371 Date: Aug. 20, 2010

(30) Foreign Application Priority Data
Nov. 16, 2007 (GB) 0722461.1

(51) Int. Cl. C08G 18/22; B01J 31/02; B01J 31/04; B01J 31/18; C08G 18/18

(52) U.S. Cl. 528/56; 502/150; 502/161; 502/171; 502/162; 502/167; 252/182.2

(57) ABSTRACT

The invention provides a polyurethane catalyst composition comprising a compound of titanium, zirconium or hafnium and a co-catalyst which is a compound effective as a polyisocyanate trimerisation catalyst.

The present invention concerns polyurethanes and catalysts for use in their manufacture. In particular the invention concerns catalysts comprising a combination of certain titanium and zirconium compounds with certain amine compounds.

Polyurethane materials may be made by reacting together a compound having more than one isocyanate function, i.e. a polyisocyanate, with a compound having more than one hydroxyl function, i.e. a polyol. In most cases a catalyst is added to the reaction mixture to accelerate the reaction and ensure complete and reproducible reaction conditions. Many catalysts are known and used for polyurethane manufacture, the most common being compounds of tin or mercury and also organic amine compounds. In many applications, metal catalysts are preferred because they are efficient and very effective. Whilst the use of heavy metal catalysts in polyurethane goods may not now be desirable because of concerns regarding toxicity to the environment, the alternative metals have disadvantages, particularly in terms of shelf life, stability to hydrolysis and in their ability to form polyurethanes having the required mechanical properties. Titanium compounds, in particular, have the potential to offer economical alternatives which are of low toxicity compared with mercury for example. A problem with compounds of titanium and some other metals such as aluminium and zirconium, which are very effective catalysts, is that they may not provide the required reaction profile for the manufacture of polyurethane products having desirable mechanical properties. Some of these catalysts may also be rapidly hydrolysed in the presence of water to less catalytically active or inactive compounds.

According to the invention, we provide a method of forming a polyurethane by mixing together a composition containing at least one polyol, at least one polyisocyanate compound and a catalyst composition and allowing the mixture to cure to form a polyurethane, characterised in that the catalyst composition comprises a metal-organic compound of Ti, Zr or Hf and a co-catalyst, said co-catalyst being a compound which is effective as a polyisocyanate trimerisation catalyst.

As a second aspect of the present invention, we provide a composition for use in making polyurethane materials comprising at least one of a polyol and a polyisocyanate, a catalyst composition comprising a metal-organic compound of Ti, Zr or Hf and a co-catalyst, said co-catalyst being a compound which is effective as a polyisocyanate trimerisation catalyst, and optionally at least one other additive.

As a further aspect of the invention we provide a catalyst composition comprising a metal-organic compound of Ti, Zr or Hf and a co-catalyst, said co-catalyst being a compound which is effective as a polyisocyanate trimerisation catalyst.

The organic compound of Ti, Zr or Hf may be selected from a variety of compounds. Preferably the metal-organic compound is a compound of Ti or Zr, most preferably Ti. Suitable metal-organic compounds are selected from metal alkoxides, salts of organic acids and chelates. Suitable compounds generally have the formula M(L)₄ where M represents a metal atom and each L independently represents a ligand derived from an alkoxide, an aryloxide, a deprotonated acid anion, a betadiketonate anion, a betaketoester such as an alkylacetoacetonate anion, or an N,N-dialkylacetoacetamide anion. Alternatively, the metal-organic compound may be a chelate of the metal with one or more multi-dentate ligands, represented by the general formula M(L)ₓ, where x<4. Suitable multidentate ligands may be derived from trialkylamines, polyphenols, polyfunctional carboxylic acids or derivatives thereof, alpha-hydroxyacids (e.g. citric acid, lactic acid), polyols, acid phosphates and phosphate esters such as mono and/or dialkyl acid phosphates, salicylic acid and others. A preferred multidentate ligand comprises an N,N,N′,N′-tetrakis(2-hydroxyalkyl)ethylenediamine which forms a hydrolytically stable metal chelate with titanium and zirconium. Additional ligands may also be present, including the alkoxide, an aryloxide, a deprotonated acid anion, a betadiketonate anion, a betaketoester such as an alkylacetoacetonate anion, an N,N-dialkylacetoacetamide anion mentioned above.

The co-catalyst is preferably an organic nitrogen-containing compound selected from quaternary ammonium compounds and amines. Although organic amines are well known as catalysts for curing polyurethane compositions, it is an important feature of the present invention that the co-catalyst is effective for the reaction of an isocyanate group with another isocyanate group or a urethane group to form a trimer, allophanate or biuret moiety, which enables the catalyst composition to form cross-links in the polyurethane material in order to build the required physical properties to produce a strong polyurethane product with desirable mechanical properties. Trimerisation is the result of the reaction of polyisocyanates and isocyanate ended-polyurethane molecules with other isocyanate groups to form stable trimers, known as polyisocyanurates. The co-catalyst, when mixed with an aromatic isocyanate, is preferably capable of producing trimer at temperatures below 80° C. Suitable co-catalysts include amines such as N,N′,N″-tris(N,N′-(dialkylamino)alkyl)hexahydro-s-triazines, for example 1,3,5-tris(3-(dimethylamino)propyl)hexahydro-s-triazine available under the trade names: POLYCAT™41, NIAX™C-41, JEFFCAT™TR41, LUPRAGEN™N600, JEFFCAT™TR90 and TOYOCAT™-TRC; 1,3,5-tris(N,N-dimethyl-2-aminoethyl)-s-hexahydrotriazine, 1,3,5-tris(N,N-dimethyl-2-aminopropyl)-s-hexahydrotriazine, 1,3,5-tris(N,N-diethyl-2-aminoethyl)-s-hexahydrotriazine, 1,3,5-tris(N,N-diethyl-3-aminopropyl)-s-hexahydrotriazine, 1,3,5-tris(N,N-dipropyl-2-aminoethyl)-s-hexahydrotriazine; pentamethyldiethylenetriamine e.g. as sold as POLYCAT™5, POLYCAT™9, DABCOT™F02051, POLYCAT™SA-1, POLYCAT™ DBU; the proprietary blend of trimerisation amines sold as DABCO TMR-13, N-methyldicyclohexylamine sold under the trade name of POLYCAT™12, N,N-dimethylethanolamine, N,N-dimethylcyclohexylamine, N,N-dimethylbenzylamine, N,N,N′,N′-tetramethyl-1,3-butanediamine, N,N,N′,N′-tetramethylpropanediamine, N-methylmorpholine, N-ethylmorpholine, triethylene diamines, mono(dialkylaminoalkyl)phenols, dialkylaminoalkoxyalcohols such as dimethylaminoethoxyethanol (sold as DABCO DMAEE, JEFFCAT™ ZR-70), and 2,4,6-tris(alkylaminoalkyl)phenols such as 2,4,6-tris(dimethylaminomethyl)phenol (e.g. DABCO™ TMR-30, JEFFCAT™ TR30). The N,N′,N″-tris(N,N′-(dialkylamino)alkyl)hexahydro-s-triazines are preferred trimerisation catalysts, in particular 1,3,5-tris(N,N-dimethyl-3-aminopropyl)-s-hexahydrotriazine which can also be designated as 1,3,5-tris(3-dimethylaminopropyl)-s-hexahydrotriazine.

Other suitable trimerisation catalysts include alkali metal or, more preferably, quaternary ammonium salts of oxygen-containing acids, especially carboxylic acids, sulphonic acids and phosphorus-containing acids such as phosphoric, phosphonic and phosphinic acids and their alkyl esters. The carboxylic acids, sulphonic acids and phosphorus-containing acids may optionally contain additional ester or amide functionality as described in U.S. Pat. No. 4,540,781. Suitable examples of trimerisation catalysts comprising quaternary ammonium salts include DABCO™TMR, hydroxyalkyltrialkylammonium carboxylates, e.g. 2-hydroxypropyltrimethylammonium octylate, 2-hydroxypropyltrimethylammonium formate, DABCO™TMR-2, DABCO™TMR-3, hydroxyalkyl ammonium formate, DABCO™TMR-5, CURATHANE™52, ADDOCAT™1594, methyltriethylammonium octylate, methyltriethylammonium formate, N-8-methyl-1,8-diazabicyclo[5,4,0]-7-undecene octylate. Other compounds may also be suitable, for example, an N,N-dialkylacetoacetamide, e.g. N,N-diethylacetoacetamide, or a or a 2,3-dialkyltetrahydropyrimidine such as 2,3-dimethyltetrahydropyrimidine. Sodium glycinate and other alkali metal compounds may also be suitable. DABCO and POLYCAT are trademarks of Air Products Inc, JEFFCAT is a trademark of Huntsman Inc, ADDOCAT is a trademark of the RheinChemie Group, TOYOCAT is a trademark of the Tosoh Corporation.

The relative amounts of the metal-organic compound and the co-catalyst in the catalyst composition should be selected to provide an optimised balance of urethane formation (i.e. gelling activity) and cross-linking so that the skilled person would select the proportions of metal-organic compound and co-catalyst used according to the nature of the catalyst compounds, the polyol and isocyanate used and the properties required from the finished product. Typically the amounts of metal-organic compound and the co-catalyst in the catalyst composition are from 1 to 20 parts by weight (pbw) of the metal-organic compound and from 1 to 20 pbw of the co-catalyst. Preferably the relative amount of metal-organic compound to co-catalyst is in the range 1:10 to 2:1 (metal-organic compound:co-catalyst expressed as weight ratios).

The metal-organic compound and the co-catalyst are preferably mixed to form a mixed catalyst composition, which is preferably in the liquid phase. Alternatively, but less preferably the metal-organic compound and the co-catalyst are added to one of the polyurethane reactants (i.e. the polyol composition or the polyisocyanate compound) separately. The catalyst composition is preferably supplied as a formulated composition containing a solvent or diluent, which may be present in quantities representing up to 99% of the weight of the total composition (i.e. including the diluent). The solvent or diluent may comprise a protic solvent such as water, an alcohol, diol or polyol, a glycerol-based oil, especially a naturally derived oil such as castor oil, rape-seed oil etc, a carbonyl compound, especially a ketone, diketone or ketoester. Any other diluent which is miscible with the polyol, polyisocyanate or prepolymer used in the polyurethane formulation may be used. In some formulations, it is preferred to use as a diluent a liquid component which is already present in or which is compatible with the polyurethane reaction components, such as a diol or polyol which may function as a chain extender e.g. 1,4-butane diol or diethylene glycol. Preferred diluents include 1,3-propanediol, 1,4-butanediol, diethylene glycol, glycerol, and natural oils such as castor oil, coconut oil and rape-seed oil.

Some polyurethane compounds, such as foams, are made from a reaction mixture to which a small percentage of water is added. In such a case the catalyst must be stable in the presence of water. In other cases the polyol composition of a two-part polyurethane reaction mixture contains water due to the hygroscopic nature of many polyols. It is common practice in the polyurethane supply-chain to supply a two-part polyurethane formulation to an end-user in which the catalyst is already present, usually in the polyol-containing part. The user then mixes together the two parts and shapes the mixture before it cures to form a polyurethane material. The polyol, containing the catalyst, must therefore be stable during the period from manufacture to use and this may be a period of several months, depending on the application. If the catalyst/polyol mixture is not stable then changes in the catalyst activity can greatly affect the efficacy of the catalyst and thereby the properties of the cured polyurethane. In order to provide a stable catalyst composition for such applications, it is preferred to use as a metal-organic compound a compound which is a chelate of Ti with N,N,N′,N′-tetrakis(2-hydroxyethyl)ethylenediamine or N,N,N′,N′-tetrakis(2-hydroxypropyl)ethylenediamine.

The process of the invention comprises the reaction between a hydroxyl-functionalised molecule, such as a polyol, and an isocyanate-functionalised molecule, such as a polyisocyanate to form a polyurethane in the form of an elastomer, an adhesive, a foam, a thermoplastic mouldable material, a coating or any other useful physical form. This reaction forms the basis of many commercially available two-component polyurethane systems.

The polyol component may be any suitable for the manufacture of polyurethanes and includes polyester-polyols, polyester-amide polyols, polyether-polyols, polythioetherpolyols, polycarbonate polyols, polyacetal polyols, polyolefin polyols, polysiloxane polyols, dispersions or solutions of addition or condensation polymers in polyols of the types described above, often referred to as “polymeric” polyols. Many different polyols have been described in the prior art and these are well known to the formulator of polyurethane materials.

Typically, a mixture of polyols is used to manufacture polyurethane having particular physical properties. The polyol or polyols is selected to have a molecular weight, backbone type and hydroxy functionality which is tailored to the requirements of the formulator. The polyol composition may include a chain extender, which is often a relatively short-chain diol such as 1,4-butane diol or diethylene glycol or a low molecular weight polyethylene glycol. Alternative chain extenders in commercial use, such as diamines, e.g. MOCA (4,4-methylene bis(2-chloroaniline)) may also be used.

The isocyanate compositions used for polyurethane manufacture suitable for use with the catalysts of the present invention may be any organic polyisocyanate compound or mixture of organic polyisocyanate compounds which are commercially useful for the purpose. Preferably the polyisocyanate is liquid at room temperature. Suitable organic polyisocyanates include diisocyanates, particularly aromatic diisocyanates, and isocyanates of higher functionality. Examples of suitable organic polyisocyanates include aliphatic isocyanates such as hexamethylene diisocyanate and isophorone diisocyanate; and aromatic isocyanates such as m- and p-phenylene diisocyanate, tolylene-2,4- and tolylene-2,6-diisocyanate, diphenylmethane-4,4′-diisocyanate, chlorophenylene-2,4-diisocyanate, naphthylene-1,5-diisocyanate, diphenylene-4,4′-diisocyanate, 4,4′-diisocyanate-3,3′-dimethyl-diphenyl, 3-methyldiphenylmethane-4,4′-diisocyanate and diphenyl ether diisocyanate; and cycloaliphatic diisocyanates such as cyclohexane-2,4-and-2,3-diisocyanate, 1-methylcyclohexyl-2,4-and-2,6-diisocyanate and mixtures thereof and bis-(isocyanatocyclohexyl)methane and triisocyanates such as 2,4,6-triisocyanatotoluene and 2,4,4-tri-isocyanatodiphenylether. Modified polyisocyanates containing isocyanurate, carbodiimide or uretonimine groups may be used. The polyisocyanate may also be an isocyanate-ended prepolymer made by reacting an excess of a diisocyanate or higher functionality polyisocyanate with a polyol for example a polyether polyol or a polyester polyol. The use of prepolymers is common in commercially available polyurethane systems. In these cases, polyols may already be incorporated in the isocyanate or prepolymer whilst further components such as chain extenders, polyols, etc. may be mixed with the isocyanate prepolymer mixture before polymerisation. Mixtures of isocyanates may be used, for example a mixture of tolylene diisocyanate isomers such as the commercially available mixtures of 2,4- and 2,6-isomers. A mixture of di- and higher polyisocyanates, such as trimers (isocyanurates) or pre-polymers, may also be used.

Polyisocyanate mixtures may optionally contain monofunctional isocyanates such as p-ethyl phenylisocyanate.

The catalyst composition is typically added to the polyol prior to mixing together the polyol component with the isocyanate component to form the polyurethane. The mixture of the catalyst composition and the polyol component may be stored after mixing and prior to use to form a polyurethane.

A composition containing a catalyst composition of the present invention and a polyol and compounds reactive therewith may further comprise conventional additives such as chain modifiers, diluents, flame-retardants, blowing agents, release agents, water, coupling agents, lignocellulosic preserving agents, fungicides, waxes, sizing agents, fillers, colourants, impact modifiers, surfactants, thixotropic agents, plasticisers, and binders. Additional catalysts may also be present such as blowing catalysts and secondary catalysts, e.g. amines. The selection of these and other ingredients for inclusion in a formulation for a polyurethane composition is well known to the skilled person and may be selected for the particular purpose. When the mixture has been allowed to cure it may be further conditioned to allow for post-cure. Typically this occurs when the polyurethane article, coating, etc. has hardened to a state in which it may be handled and/or de-moulded and then it may be held at elevated temperature, e.g. by placing in an oven, to develop or enhance the full cured properties of the article.

The process and compositions of the present invention are useful for the manufacture of polyurethane foams, flexible or rigid articles, coatings, adhesives, elastomers, sealants, thermoplastic polyurethanes, and binders. The catalysts of the present invention may also be useful in preparing polyurethane prepolymers, i.e. urethane polymers of relatively low molecular weight which are supplied to end-users for curing into polyurethane articles or compositions of higher molecular weight.

The catalyst composition is typically present in the isocyanate and/or polyol mixture to give a concentration in the range 1×10⁻⁴ to 10% by weight, preferably up to about 2% by weight based upon the weight of the total reaction system, i.e. the total weight of the polyisocyanate and polyol components.

The invention will be further described in the following examples with reference to the drawings.

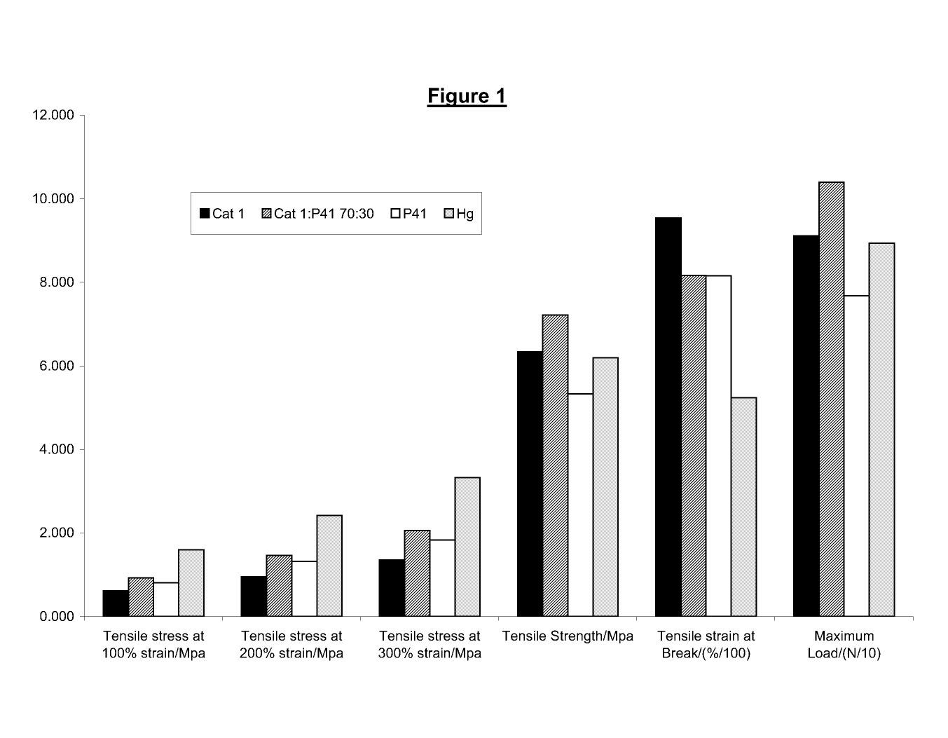

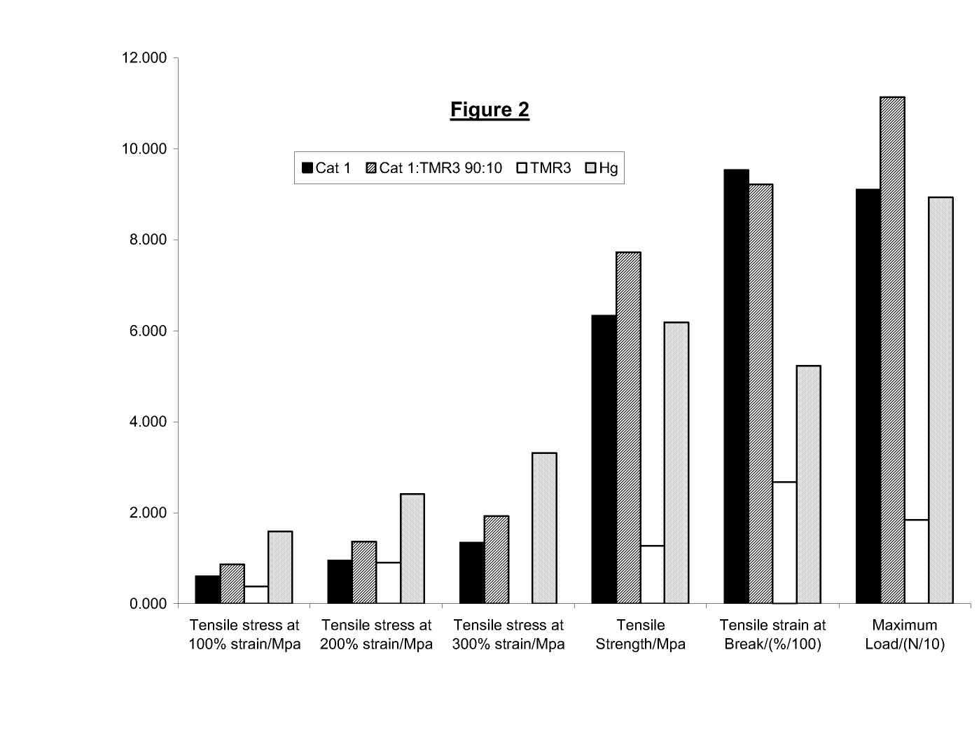

FIGS. 1 and 2 are charts showing the mechanical properties of elastomers made according to the method of the invention, using a catalyst composition of the invention.

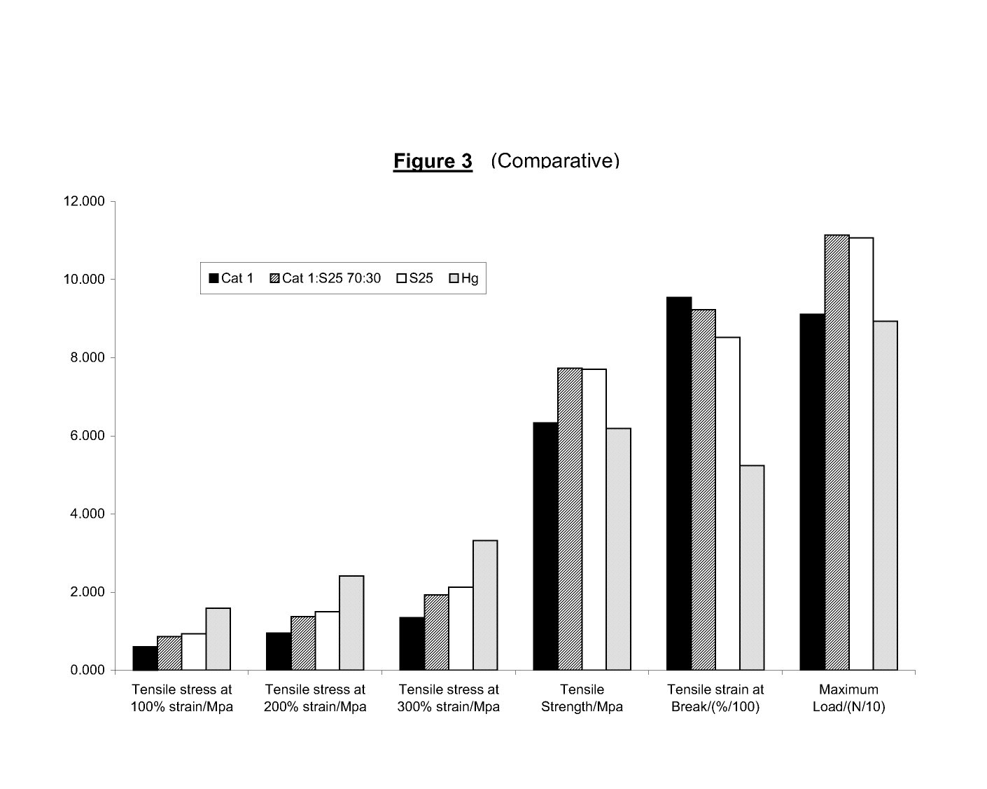

FIG. 3 is a chart showing the mechanical properties of elastomers made using a comparative catalyst composition.

### EXAMPLE 1

### Preparation of Cat 1

Tetraisopropyl titanate (VERTEC™ TIPT) was reacted with acetylacetone in the mole ratio 1 TIPT:2 acetylacetone. The reaction was exothermic and the solution turned orange/yellow. To this was added 1 mole of N,N,N′,N′-tetra(hydroxypropyl)ethylenediamine and the complex was heated at 60° C. for 30 mins and mixed with 1,3-propanediol to a weight ratio 90% propane diol:10% metal complex to form Cat 1.

### EXAMPLE 2

### Polyurethane Elastomer

(a) A polyol composition was made up according to the recipe in Table 1 and allowed to equilibrate for 24 hours.

TABLE 1

| | | | | Mix |
|---|---|---|---|---|
| | | Parts by | | temperature |
| OH value | compound | weight | % (polyol) | ° C. |
| 56 | *PPG 56-07 | 47 | 46.26 | 40 |
| 28 | *6 K triol | 47 | 46.26 | 40 |
| 1245 | 1,4-butane diol | 6 | 5.91 | 40 |
| 0 | Molecular sieve | 1.5 | 1.48 | 40 |
| 0 | Silicone anti-foam | 0.1 | 0.10 | 40 |
| | TOTAL | 101.6 | 100.00 | |

*product commercially available from the Dow Chemical Company.

(b) Prepolymer synthesis

An isocyanate-ended prepolymer was made according to the following procedure. 4,4-MDI (1201.7 g) was placed into a reactor and heated until liquid (about 60° C.). 2000 MW polypropylene glycol (793.3 g) was then added into the reactor via a dropping funnel and the heat maintained at 60° C. The mixture was heated until the exotherm occurred and then heated to 110° C. and maintained at that temperature for three hours to produce a quasi prepolymer: calculated NCO content=18.6%, calculated viscosity=300 cps.

(c) Polyurethane elastomer preparation

Between 0.3-0.7 wt % (based on the weight of polyol+catalyst) of the catalyst composition shown in Table 2 was added to between 20-100 g of the polyol composition described in (a) and mixed on a centrifugal mixer for 30 seconds. The corresponding amount of prepolymer (b) was then added to the polyol/catalyst mixture at a ratio of 100 parts by weight of the polyol to 49 parts by weight of the prepolymer (index NCO:OH=1.03) and mixed on a centrifugal mixer for another 30 seconds. The reaction mixture was then degassed under vacuum. A portion of the mixture was poured into a small disk shaped mould on a hot plate at 80° C. and the rest into a 50 ml plastic cup at room temperature (RT). The gel-time was recorded as the earliest time that no material is removed when touched with a spatula. The results are shown in Table 2. The co-catalysts used are P41=POLYCAT™41 (1,3,5-tris(3-(dimethylamino)propyl)hexahydro-s-triazine), TMR3=DABCO™ TMR-3 (a hydroxyalkylammonium formate), PMET (pentamethyldiethylenetriamine) and S25=DABCO™ S-25, all available from Air Products. A commercial mercury-containing catalyst, HgT535, was tested as a comparison. In Table 2, the experiments D & F are examples of a catalyst composition and process according to the invention. The rest are shown for comparison.

TABLE 2

| | | wt % | 80° C. hot | RT gel- | |
|---|---|---|---|---|---|
| | | in | plate | time | |
| | Catalyst | polyol | gel-time | (min:sec) | Notes |
| A* | Hg T535 | 0.7 | 4:00 | 9:00 | Good RT gel-time |
| B* | Cat 1 | 0.7 | 4:30 | 14:00 | Titanium Catalyst |
| C* | P41 | 0.4 | 4:30 | 20:00 | Trimerisation amine |
| D | 70% Cat 1 + | 0.3 | 4:30 | 10:00 | Improved RT gel- |
| | 30% P41 | | | | time |
| E* | TMR3 | 0.4 | 4:30 | 18:00 | Trimerisation amine |
| F | 70% Cat 1 − | 0.3 | 3:40 | 6:00 | Improved RT gel- |
| | 30% TMR3 | | | | time |
| G* | PMET | 0.6 | 7:00 | 10:00 | Blowing Amine |
| H* | 70% Cat 1 + | 0.3 | 4:30 | 19:00 | poor RT gel-time |
| | 30% PMET | | | | |
| I* | S25 | 0.4 | 6:30 | 9:00 | Gelling amine |
| J* | 70% Cat 1 + | 0.3 | 5:30 | 15:00 | poor RT gel-time |
| | 30% S25 | | | | |

*Compositions A, B, C, E, G, H, I & J are all comparison examples. Compositions D and F are compositions according to the invention.

The results show that use of Cat 1, POLYCAT 41, PMET, DABCO TMR-3 and S-25 alone give longer gel-times compared with the mercury catalyst. The compositions D and F, both containing Cat 1 and a trimerisation catalyst, show gel-times which are close to or shorter than those obtained using the mercury catalyst. PMET is primarily sold as a blowing catalyst and DABCO S-25 is a gelling catalyst. The results show that compositions H and J comprising these catalysts combined with Cat 1 produce relatively long gel-times.

### EXAMPLE 3

### Polyurethane Elastomer

Between 0.3-0.7 wt % (based on the weight of polyol+catalyst) of the catalyst composition shown in Table 3 was added to between 20-100 g of the polyol composition described in Example 2(a) and mixed on a centrifugal mixer for 30 seconds. The corresponding amount of prepolymer described in Example 2(b) was then added to the polyol/catalyst mixture at a ratio of 100 parts by weight of the polyol to 52 parts by weight of the prepolymer (index NCO:OH=1.1) and mixed on a centrifugal mixer for another 30 seconds. The reaction mixture was then degassed under vacuum and cured in a mould at room temperature. The samples were then tested using an Instron™ mechanical testing instrument. The results from 6 tests were averaged and are plotted in FIGS. 1-3.

TABLE 3

| | Catalyst Composition | wt % in |
|---|---|---|
| | (parts by weight) | polyol |
| K* | Cat 1 | 0.5 |
| L | Cat 1:P41 (70:30) | 0.1 |
| M* | P41 | 0.3 |
| N | Cat 1:TMR3 (90:10) | 0.15 |
| O* | TMR3 | 0.5 |
| P* | Cat 1:S25 (70:30) | 0.3 |
| Q* | S25 | 0.4 |
| R* | Hg | 0.25 |

*Compositions K, M, O, P, Q & R are all comparison examples. Compositions L and N are compositions according to the invention.

### EXAMPLE 4

### Preparation of Cat 2

75 wt % Ti(2,4-pentanedionate)₂(OⁱPr)₂ in 25 wt % isopropanol was mixed with 1,3-propane diol to a weight ratio 90% 1,3-propane diol:10% metal complex to form Cat 2.

### EXAMPLE 5

### Preparation of Cat 3

Tetra-n-propoxy zirconate solution (VERTEC™ NPZ) was reacted with N,N-diethylacetoacetamide in the mole ratio 1 Zr:4 N,N-diethylacetoacetamide. The reaction was exothermic and the solution turned orange. To this was added 1 mole equivalent of diethylene glycol and then this reaction mixture was heated at 115° C. and stripped of free n-propanol by distillation under vacuum. The resulting zirconate composition was mixed with 1,3-propanediol to a weight ratio 90% 1,3-propanediol:10% zirconate composition to form Cat 3.

### EXAMPLE 6

### Polyurethane Elastomer

(a) A polyol composition was made up according to the recipe in Table 1 and allowed to equilibrate for 24 hours.

(b) Polyurethane elastomer preparation

Between 0.1 and 0.6 wt % (based on the weight of polyol+catalyst) of the catalyst composition shown in Table 4 was added to between 20-100 g of the polyol, and the mixture was mixed on a centrifugal mixer for 30 seconds. A commercially available MDI based isocyanate prepolymer (NCO content 23%) was then added to the polyol at a ratio of 72.3 parts by weight of the polyol to 27.7 parts by weight of the prepolymer (index NCO:OH=1.03) and mixed on a centrifugal mixer for another 30 seconds. A portion of the mixture was poured into a small disk shaped mould on a hot plate at 80° C. and the rest into a 50 ml plastic cup at room temperature (RT). The gel-time was recorded as the earliest time that no material is removed when touched with a spatula. The results are shown in Table 4. The co-catalyst used is DABCO™ TMR-3. Hg T535, a commercial mercury-containing catalyst, is shown for comparison. In Table 4, the experiments V and W are examples of a catalyst composition and process according to the invention. The rest are shown for comparison.

TABLE 4

| | | wt % | 80° C. hot | RT gel- | |
|---|---|---|---|---|---|
| | | in | plate | time | |
| | Catalyst | polyol | gel-time | (min:sec) | Notes |
| S* | Hg T535 | 0.6 | 7:30 | 12.30 | Poor RT gel-time |
| T* | Cat 2 | 0.5 | 7:00 | 7:00 | Titanium Catalyst |
| U* | Cat 3 | 0.5 | 7:00 | 7:00 | Zirconium Catalyst |
| V | 70% Cat 2 + | 0.1 | 7:30 | 7:30 | Reduced catalyst |
| | 30% TMR3 | | | | loadings, improved |
| | | | | | RT gel-time |
| W | 70% Cat 3 + | 0.2 | 7:30 | 9:30 | Reduced catalyst |
| | 30% TMR3 | | | | loadings |
| X* | TMR3 | 0.4 | 7:30 | 9:00 | Trimerisation amine |
| Y* | TMR3 | 0.6 | 6:30 | 7:00 | Trimerisation amine |

*Compositions S, T, U, X & Y are all comparison examples. Compositions V and W are compositions according to the invention.

The results show that combinations of titanium or zirconium chelates with a trimerisation amine co-catalyst, i.e. compositions V and W, are more reactive than the individual species in that they produce acceptably short gel-times when used in relatively small amounts.

1. A catalyst composition comprising a metal-organic compound of a metal selected from the group consisting of Ti, Zr and Hf and a co-catalyst, said co-catalyst being a compound which is effective as a polyisocyanate trimerisation catalyst.

2. A catalyst composition according to claim 1, wherein the metal-organic compound is selected from the group consisting of metal alkoxides, metal salts of organic acids and metal chelates.

3. A catalyst composition according to claim 2, wherein the metal-organic compound is represented by the general formula M(L)₄ where each L independently represents a ligand derived from a compound selected from the group consisting of an alkoxide, an aryloxide, a deprotonated acid anion, a betadiketonate anion, a betaketoester anion, and an N,N-dialkylacetoacetamide anion.

4. A catalyst composition according to claim 2, wherein the metal-organic compound is a chelate of the metal with one or more multi-dentate ligands, and is represented by the general formula M(L)x, where each L independently represents a ligand, x<4 and at least one of said ligands is derived from a compound selected from the group consisting of a trialkylamine, a polyphenol, a polyfunctional carboxylic acid or a derivative thereof, an alpha-hydroxyacid, a polyol, salicylic acid and an N,N,N′,N′-tetrakis(2-hydroxyalkyl)alkylenediamine.

5. A catalyst composition according to claim 4, wherein the metal-organic compound is a chelate of the metal with an N,N,N′,N′-tetrakis(2-hydroxyalkyl)alkylenediamine and another ligand derived from a compound selected from the group consisting of an alkoxide, an aryloxide, a carboxylic, sulphonic, phosphonic, phosphinic or phosphoric acid or ester, a betadiketone, an alkylacetoacetate and a N,N-dialkylacetoacetamide.

6. A catalyst composition according to claim 1, wherein the co-catalyst comprises a compound selected from the group consisting of an amine, an alkali metal or quaternary ammonium salt of an oxygen-containing acid, an N,N-dialkylacetoacetamide and a 2,3-dialkyltetrahydropyrimidine.

7. A catalyst composition according to claim 6, wherein the co-catalyst comprises an amine selected from the group consisting of an N,N′,N″-tris(N,N′-(dialkylamino)alkyl)hexahydro-s-triazine, a pentamethyldiethylenetriamine, an N-alkyldicyclohexylamine, a N,N-dialkylethanolamine, a N,N-diallylcyclohexylamine, a N,N-dialkylbenzylamine, a N,N,N′,N′-tetraalkyl-alkanediamine, an N-allylmorpholine, triethylene diamine, a mono(dialkylaminoalkyl)phenol, a dialkylaminoalkoxyalcohol and a 2,4,6-tris(alkylaminoalkyl)phenol.

8. A catalyst composition according to claim 6, wherein the co-catalyst comprises a quaternary ammonium salt of an acid selected from the group consisting of a carboxylic acid, a sulphonic acid, a phosphoric acid, a phosphonic acid, a phosphinic acid, an alkyl ester of phosphoric acid, an alkyl ester of phosphonic acid and an alkyl ester of phosphinic acids.

9. A catalyst composition according to claim 1, wherein the amounts of metal-organic compound and the co-catalyst in the catalyst composition are from 1 to 20 parts by weight (pbw) of the metal-organic compound and from 1 to 20 pbw of the co-catalyst.

10. A catalyst composition according to claim 1, further comprising up to 99% by weight of a solvent or diluent.

11. A catalyst composition according to claim 10, wherein the solvent or diluent comprises water, an alcohol, a diol, a polyol, a ketone, a diketone, a ketoester or a glycerol-based oil.

12. A method of forming a polyurethane by mixing together a composition containing at least one polyol, at least one polyisocyanate compound and a catalyst composition and allowing the mixture to cure to form a polyurethane, wherein the catalyst composition is a catalyst composition according to claim 1.

13. A method according to claim 12, wherein the catalyst composition is mixed with the polyol before it is mixed with the polyisocyanate.

14. A composition for use in making polyurethane materials comprising:
at least one compound selected from the group consisting of a polyol and a polyisocyanate,
a catalyst composition according to claim 1, and
optionally at least one other additive.

15. A composition according to claim 14, comprising a polyol and said catalyst composition.
